(19) United States
(12) Patent Application Publication
(10) Pub. No.: US 2008/0174990 A1
(43) Pub. Date: Jul. 24, 2008

(54) OPTICAL SYSTEM WITH SEGMENTED AND/OR FLEXIBLE REFLECTOR

(76) Inventors: Richard G. Tuck, Gambier, OH (US); R. Stephen Mulder, Tucson, AZ (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/837,122

(22) Filed: Aug. 10, 2007

Related U.S. Application Data
(60) Provisional application No. 60/828,456, filed on Oct. 24, 2006.

(51) Int. Cl. F21L 4/04

(52) U.S. Cl. 362/198

(57) ABSTRACT

An optical system includes an energy source and a reflector partially surrounding the energy source to reflect energy produced by the energy source. Preferably, the reflector is formed by segments of second order surfaces or segments approximating second order surfaces. The segments are each sized and shaped to provide a predetermined amount of energy in a predetermined energy pattern on a target surface. Additionally, the reflector is preferably a flexible reflector that can be selectively deformed from a first shape to a second shape to provide different first and second predetermined energy patterns.

### CROSS-REFERENCE TO RELATED APPLICATIONS

This application claims the priority benefit of U.S. provisional patent application No. 60/828,456 filed on Oct. 24, 2006, the disclosure of which is expressly incorporated herein in its entirety by reference.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to optical systems and, more particularly, to optical systems having reflectors such as those used for illumination.

### BACKGROUND OF THE INVENTION

Current optical systems used for illumination have reflectors that provide less than desirable performance. For example, it is difficult to obtain uniform illumination at the illumination plane. Additionally, it is difficult to obtain desired predetermined non-uniform illumination patterns. Furthermore, illumination devices using a single reflector to provide more than one illumination pattern have resulted in less than desirable performance. In each of these cases, the ineffective reflectors result in the need for additional costly optical elements such as refractors and/or larger energy source wattages and their resulting energy inefficiencies. Accordingly, there is a need for improved optical systems having reflectors.

### SUMMARY OF THE INVENTION

The present invention provides an optical system which overcomes at least some of the above-noted problems of the related art. According to the present invention, an optical system comprises, in combination, an energy source and a reflector formed by segments of second order surfaces and partially surrounding the energy source to reflect energy produced by the energy source. The segments of the second order surfaces are each sized and shaped to provide a predetermined amount of energy in a predetermined energy pattern on a target surface.

According to another aspect of the present invention, an optical system comprises, in combination, an energy source and a reflector partially surrounding the energy source to reflect energy produced by the energy source and formed by parameterized segments approximating second order surfaces sized and shaped to provide a predetermined amount of energy in a predetermined energy pattern on a target surface. The segments are parameterized as one of facets and strips.

According to yet another aspect of the present invention, an optical system comprises, in combination, an energy source, a flexible reflector having a first shape and partially surrounding the energy source to reflect energy produced by the energy source, and a deformer for selectively deforming the flexible reflector to a second shape. The first shape provides a first predetermined energy pattern and the second shape provides a second predetermined energy pattern.

According to yet another aspect of the present invention, an optical system comprises, in combination, an energy source, a reflector partially surrounding the energy source to reflect energy produced by the energy source, and a window sized and shaped so that energy reflected by the reflector is received by the window substantially normal to an inner surface of the window.

From the foregoing disclosure and the following more detailed description of various preferred embodiments it will be apparent to those skilled in the art that the present invention provides a significant advance in the technology of optical systems. Particularly significant in this regard is the potential the invention affords for providing a high quality, reliable, uniformly distributing, multi-pattern, and/or efficient optical system. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of a handheld flashlight according a first preferred embodiment of the present invention, showing an off position;

FIG. 2 is a rear elevational view of the handheld flashlight of FIG. 1;

FIG. 3 is a sectional view taken along line 3-3 of FIG. 2;

FIG. 4 is an enlarged, fragmented view taken along line 4 of FIG. 2;

FIG. 5 is an exploded perspective view of the handheld flashlight of FIGS. 1 to 4;

FIG. 6 is a perspective view of a reflector housing of the handheld flashlight of FIGS. 1 to 5;

FIG. 7 is a front elevational view of the reflector housing of FIG. 6;

FIG. 8 is a sectional view taken along line 8-8 of FIG. 7;

FIG. 9 is a sectional view taken along line 9-9 of FIG. 7;

FIG. 10A is a perspective view of a segmented and untrimmed reflector of the handheld flashlight of FIGS. 1 to 5;

FIG. 10B is a diagrammatic view of a first ellipsoid which forms a first segment of the segmented reflector of FIG. 10A;

FIG. 10C is a diagrammatic view of a second ellipsoid which forms a second segment of the segmented reflector of FIG. 10A;

FIG. 10D is a diagrammatic view of a third ellipsoid which forms a third segment of the segmented reflector of FIG. 10A;

FIG. 10E is a diagrammatic view of one segment of the reflector of FIG. 10A showing several ray paths from the light source to the focal point on the illumination plane;

FIG. 10F is a diagrammatic view of a variety of alternative illumination planes showing that the segmented reflector of FIG. 10A can be sized and shaped for different shapes of illumination patterns at the illumination plane and for different quantities and patterns of focal points at the illumination plane;

FIG. 11 is a right side elevational view of a segmented and trimmed reflector of the handheld flashlight of FIGS. 1 to 5;

FIG. 12 is a top plan view of the reflector of FIG. 11;

FIG. 13 is a front elevational view of the reflector of FIGS. 11 to 12;

FIG. 14 is a perspective view of an alternative parameterized reflector for the handheld flashlight of FIGS. 1 to 5;

FIG. 15 is a right side elevational view of the reflector of FIG. 14;

FIG. 15A is a plan view of a developed flat pattern for forming the reflector of FIGS. 14 and 15;

FIG. 16 is a top plan view of the reflector of FIGS. 14 and 15;

FIG. 17 is a front elevational view of the reflector of FIGS. 14 to 16;

FIG. 18 is a perspective view of an alternative reflector for the handheld flashlight of FIGS. 1 to 5;

FIG. 19 is a right side elevational view of the reflector of FIG. 18;

FIG. 20 is a top plan view of the reflector of FIGS. 18 and 19;

FIG. 21 is a front elevational view of the reflector of FIGS. 18 to 20;

FIG. 22 is an exploded perspective view of the reflector with an alternative window or lens:

FIG. 23 is a rear elevational view of the handheld flashlight of FIGS. 1 to 5 similar to FIG. 2 but showing a first or circular reflector position;

FIG. 24 is a section view taken along line 24-24 of FIG. 23;

FIG. 25 is an enlarged, fragmented view taken along line 25 of FIG. 24;

FIG. 26 is a rear elevational view of the handheld flashlight of FIGS. 1 to 5 similar to FIG. 2 but showing a second or oval reflector position;

FIG. 27 is a section view taken along line 27-27 of FIG. 26;

FIG. 28 is an enlarged, fragmented view taken along line 28 of FIG. 27;

FIG. 29 is a window of a software program showing performance characteristics of the segmented reflector of FIG. 10A;

FIG. 30 is a window of a software program showing performance characteristics of the parameterized segmented reflector of FIGS. 14 to 17;

FIG. 31 is a perspective view of a handheld flashlight according to second embodiment of the present invention showing a first or circular reflector position;

FIG. 32 is a sectional view of the handheld flashlight of FIG. 31;

FIG. 33 is a section view of the handheld flashlight of FIGS. 31 and 32 similar to FIG. 32 but showing the second or oval reflector position;

FIG. 34 is a window of a software program showing performance characteristics of the segmented reflector of FIG. 10A;

FIG. 35 A shows an equation for calculating the Coefficient of Variation (CV) which expresses uniformity of illuminance on a target surface;

FIG. 35B is a window of a software program showing an example of the standard deviation of illuminance at grid points on an illumination plane which is used in the determination of the CV;

FIG. 35C is a contour map which shows an example of near uniform distribution for a rectangular-shaped illumination pattern; and

FIG. 35D is a contour map which shows another example of near uniform distribution for a rectangular-shaped illumination pattern.

It should be understood that the appended drawings are not necessarily to scale, presenting a somewhat simplified representation of various preferred features illustrative of the basic principles of the invention. The specific design features of the optical system as disclosed herein, including, for example, specific dimensions, orientations, and shapes will be determined by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the optical systems illustrated in the drawings. In general, up or upward refers to an upward direction generally within the plane of the paper in FIG. 2 and down or downward refers to a downward direction generally within the plane of the paper in FIG. 2. Also in general, forward or front refers to a direction toward the illumination plane, that is, toward the right generally within the plane of the paper in FIG. 3, and rearward or rear refers to a direction away from the illumination plane, that is, toward the left generally within the plane of the paper in FIG. 3.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved optical system disclosed herein. The following detailed discussion of various alternative and preferred embodiments will illustrate the general principles of the invention with reference to an illumination device in the form of a handheld flashlight. Other embodiments suitable for other applications will be apparent to those skilled in the art given the benefit of this disclosure such as, for example, (1) other portable handheld illuminations devices such as lanterns, search lights, or the like, (2) other portable illumination devices such as lights attached to head straps such as miner's lights or hiking lights, lights attached to vehicles such as bicycles, lights attached to helmets such as bicycle helmets or miner's helmets, lights mounted to guns such as rifles or pistols, or the like, (3) other illumination devices, and (4) other optical systems utilizing other than visible energy.

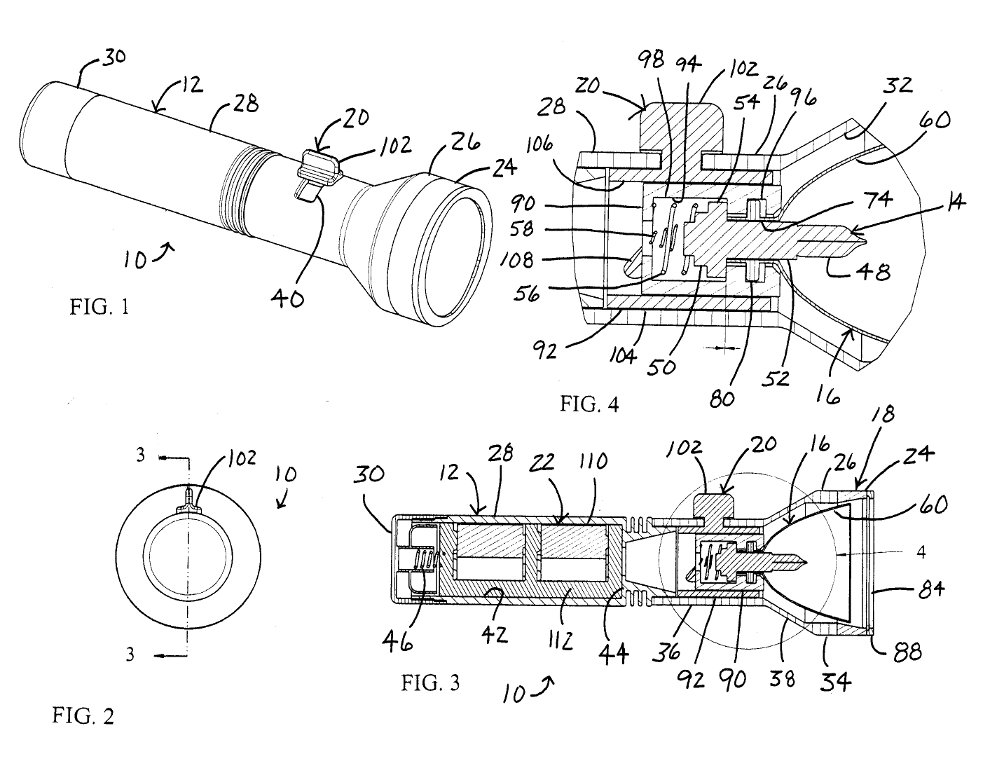

Referring now to the drawings, FIGS. 1 to 5 illustrate an optical system 10 in the form of a portable, handheld flashlight according to a first illustrated embodiment of the present invention. The illustrated flashlight 10 includes a housing assembly 12, an energy source 14, a segmented and flexible reflector 16 partially surrounding the energy source 14 to reflect energy produced by the energy source 14 out a forward end of the reflector 16, a deformer 18 for selectively deforming the flexible reflector 16 from a first shape to a second shape and holding the reflector 16 in the second shape, a beam-shape switching mechanism 20 for selectively moving at least one of the reflector 16 and the deformer 18 to change the reflector 16 between the first shape and the second shape and thus the shape of the beam produced by the system 10, and a power source and switch assembly 22 for selectively energizing the energy source 14.

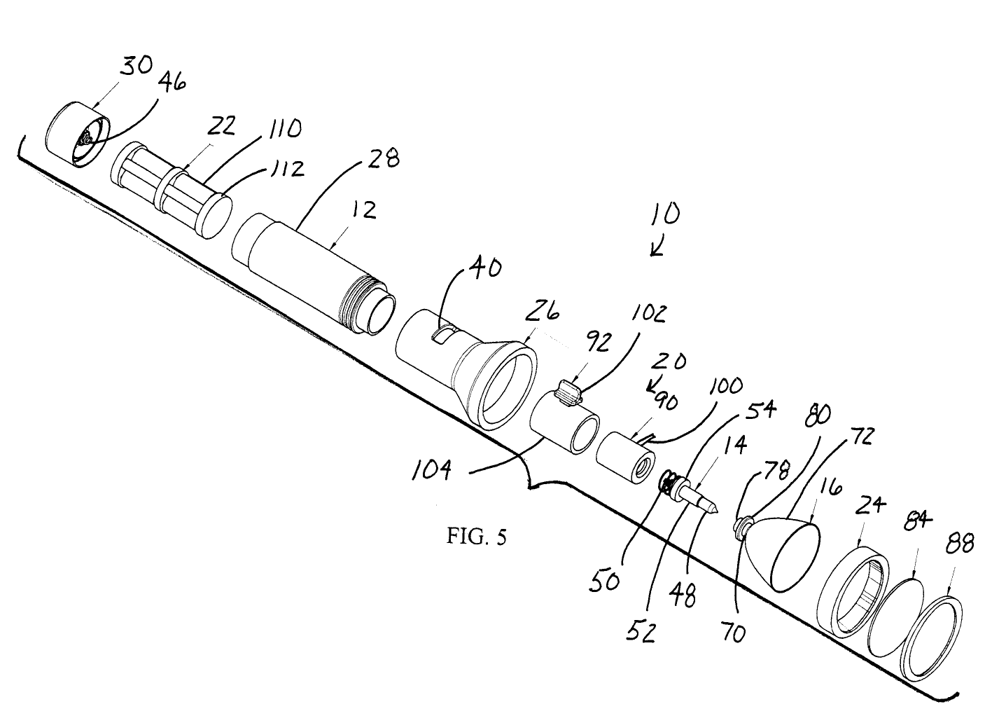

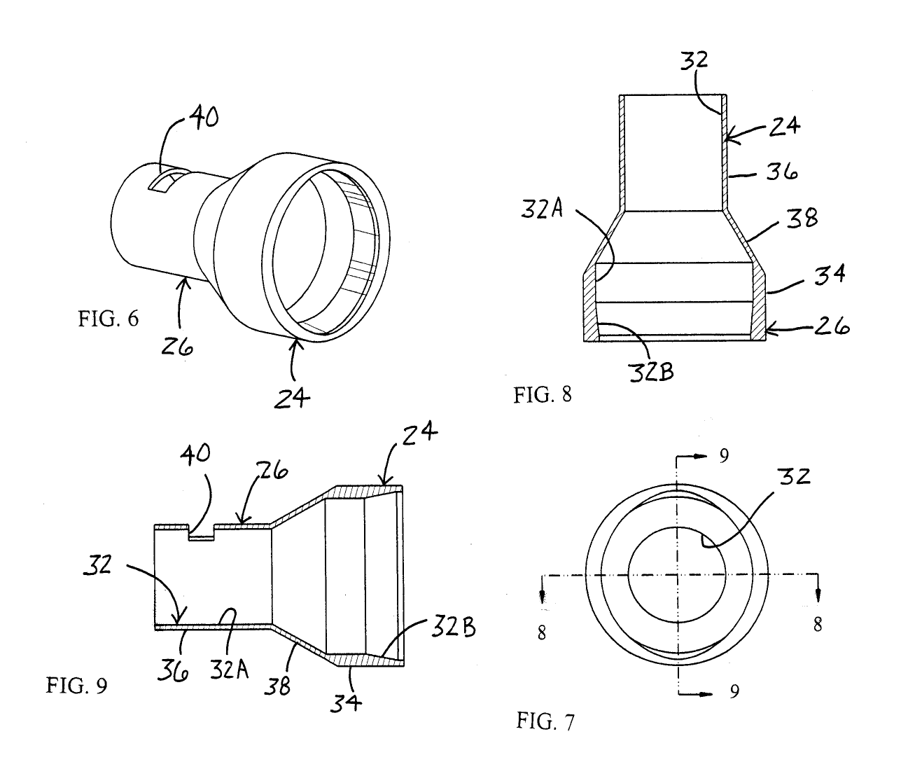

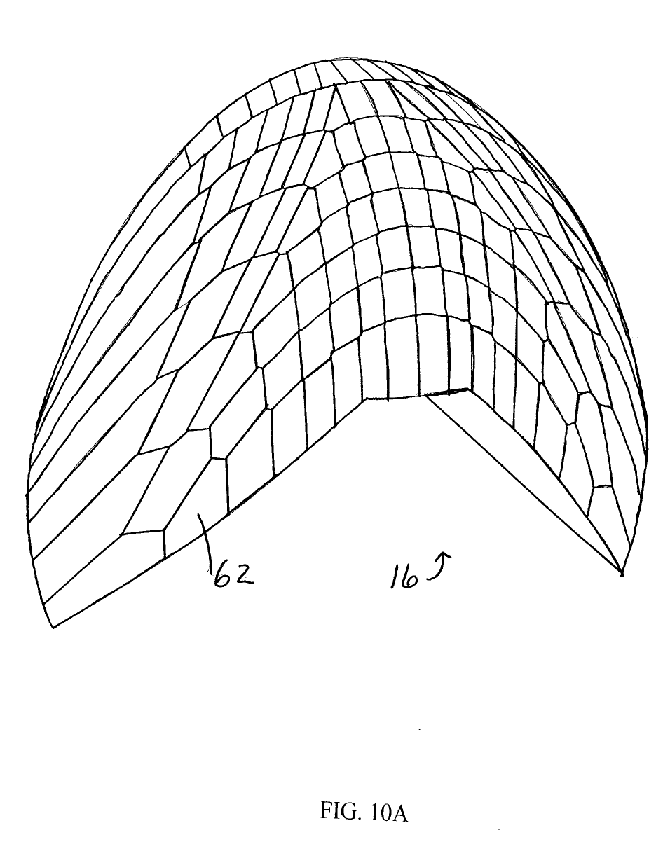

The illustrated housing assembly 12 includes front and rear reflector housings 24, 26, a main housing or body 28 extending rearwardly from the rear reflector housing 26, and an end cap 30 closing the rear end of the main body 28. As best shown in FIGS. 6 to 9, the front and rear reflector 24, 26 housings are generally cylindrically shaped having a central, longitudinally-extending passage 32 therethrough. The rear reflector housing 26 includes a first or forward portion 34, a second or rearward portion 36 having a diameter smaller than the first portion, and a central transition or third portion 38 connecting the first and second portions 34, 36. The forward and central portions 34, 38 are sized and shaped for receiving the reflector 16 therein as described in more detail hereinafter. The rearward portion 36 is sized and shaped for receiving the beam-shape switching mechanism 20 therein as described in more detail hereinafter. The illustrated rearward portion 36 is provided with a rectangular-shaped opening 40 for the switching mechanism 20. The front reflector housing 24 extends forwardly from the front of the forward portion 34 of the rear reflector housing 26 and is sized and shaped for receiving the reflector 16 therein as described in more detail hereinafter. The front and rear reflector housings 24, 26 can be separate components (as shown in FIGS. 3 and 5) secured together in any suitable manner or can alternatively be combined into an integral one piece components (as shown in FIGS. 6 to 9).

As best shown in FIGS. 3 and 5, the main body 28 is cylindrically shaped having a central, longitudinally-extending passage 42 therethrough. The forward end of the illustrated main body 28 is partially closed by a forward wall 44 having a central opening therein while the rear end is entirely open. The main body 28 is sized to cooperate with the rearward portion 36 of the rear reflector housing 26 and to receive the power source therein. The forward end of the illustrated main body 28 has a reduced diameter portion sized and shaped to be closely received within the rearward portion 36 of the rear reflector housing 26. The main body 28 and the rear reflector housing 26 can be secured together in any suitable manner. The end cap 30 is sized and shaped to close the rear end of the main body 28. The illustrated end cap 30 is suitably threadably secured to the main body 28 so that it is removable for insertion and removal of the power source. The illustrated end cap 30 is provided with a spring retainer and spring 46 for biasing the power source in a forward direction toward the forward wall 44.

The reflector housings 24, 26, the main body 28, and the end cap 30 can comprise any suitable material such as, for example, metal, plastic, or the like. It is noted that the components of housing assembly 12 can alternatively have any other suitable form within the scope of the present invention.

The illustrated deformer 18 is formed integrally within the front and rear reflector housings 24, 26. As best shown in FIGS. 7 to 9, the central passage 32A within the forward portion 34 of the rear reflector housing 26 is circular shaped and the central passage within the front reflector housing transitions from the circular shape of the rear reflector housing 26 to an oval shape so that the passage is oval-shaped at the forward end of the front reflector housing 24 with the major axis in the vertical direction. Thus, the inner surface forming the passage 32 is sized and shaped to deform the flexible reflector 16 as it axially moves relative to the reflector housings 24, 26 along the central passage 32 as described in more detail hereinafter. It is noted that the central passage 32 can alternatively have any other shapes so long as they maintain aperture perimeter and reflector surface area constraints. It is also noted that the central passage 32 can alternatively have other quantities of shapes such as, for example, three or more shapes.

As best shown in FIGS. 3 to 5, the illustrated energy source 14 is an electric light bulb or lamp of the incandescent type assembly for producing visible light. The energy source 14 extends into the reflector 16 so that energy produced by the energy source 14 is reflected in a forward direction out of the reflector 16 as described in more detail hereinbelow. It is noted that, depending on the desired performance of the optical system being utilized, the energy source 13 can be of any other suitable type such as, for example, fluorescent, high intensity discharge (including mercury vapor, metal halide, high pressure sodium, low pressure sodium), and light emitting diode (LED) or the like, and/or can produce other types of energy such as, for example, infrared or the like. The illustrated energy source or lamp assembly 14 has a light-producing lamp portion 48 at its forward end, a base portion 50 at its rear end, and a cylindrically-shaped central portion 52 located between the lamp portion 48 and the base portion 50. The illustrated base portion 50 includes a radially-extending flange 54 which forms a forward-facing, annular-shaped abutment contiguous with the rear end of the central portion 52. The illustrated energy source 14 also includes first and second electrical contact springs 56, 58 rearwardly extending from the base portion 50 for suitable connection with the power source and switch assembly 22.

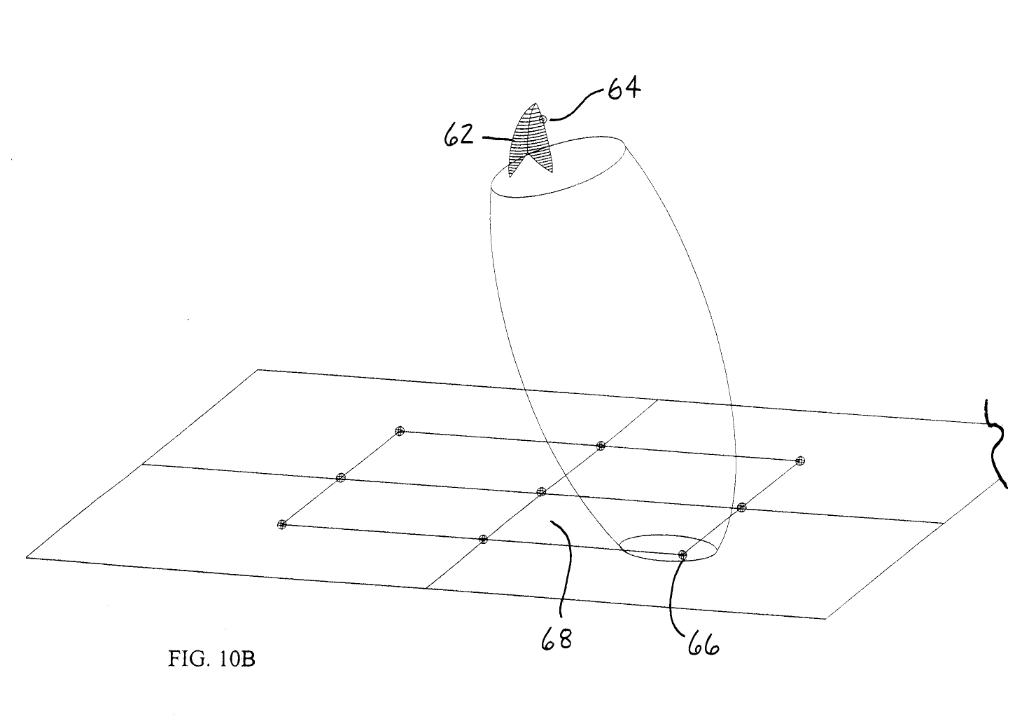

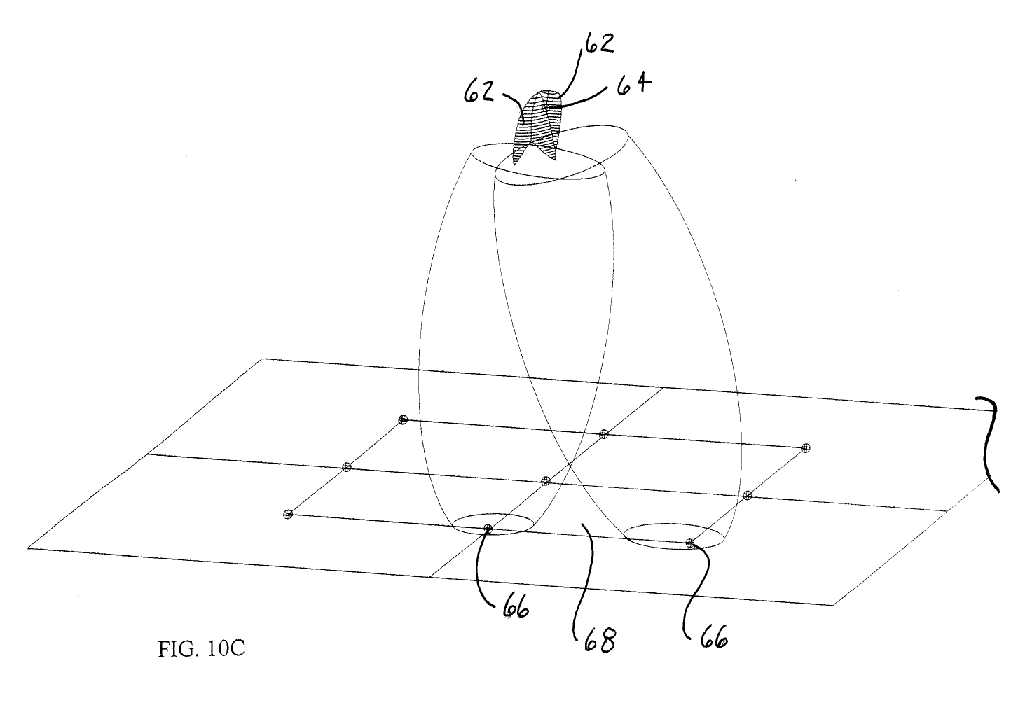

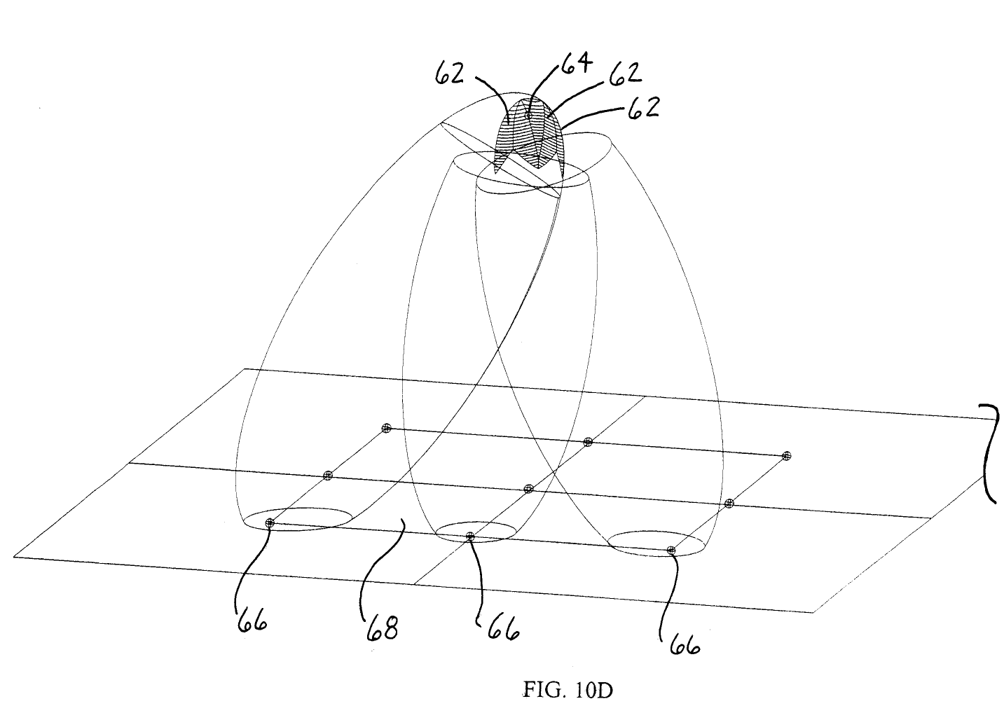

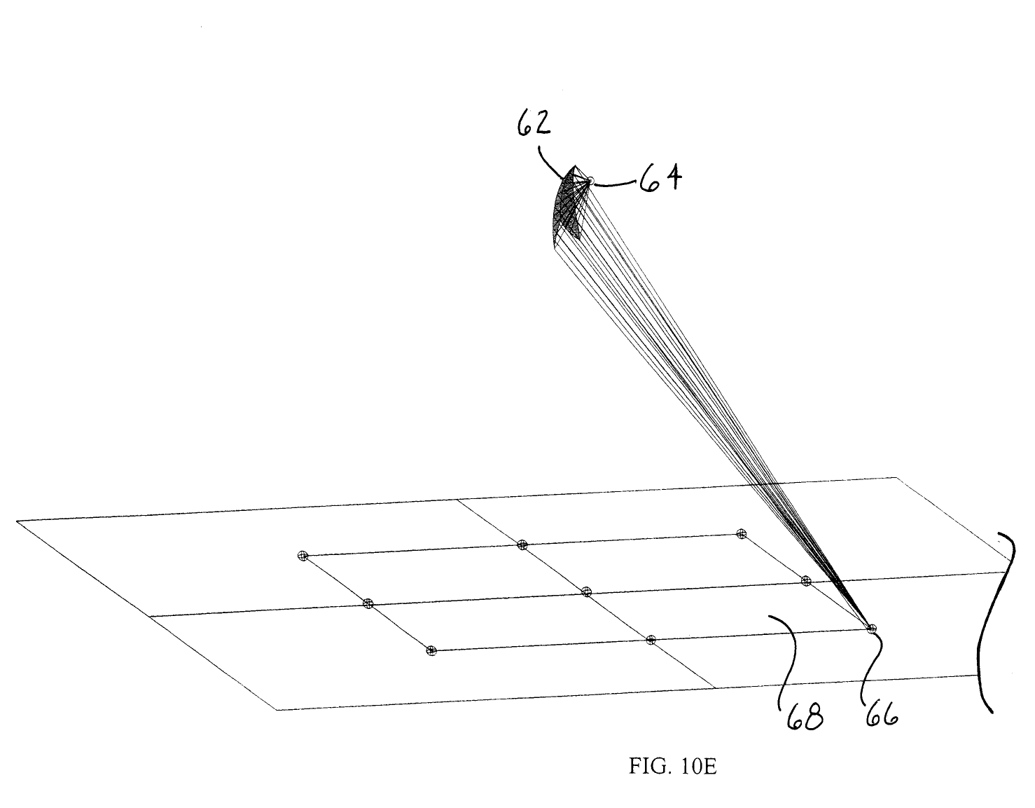

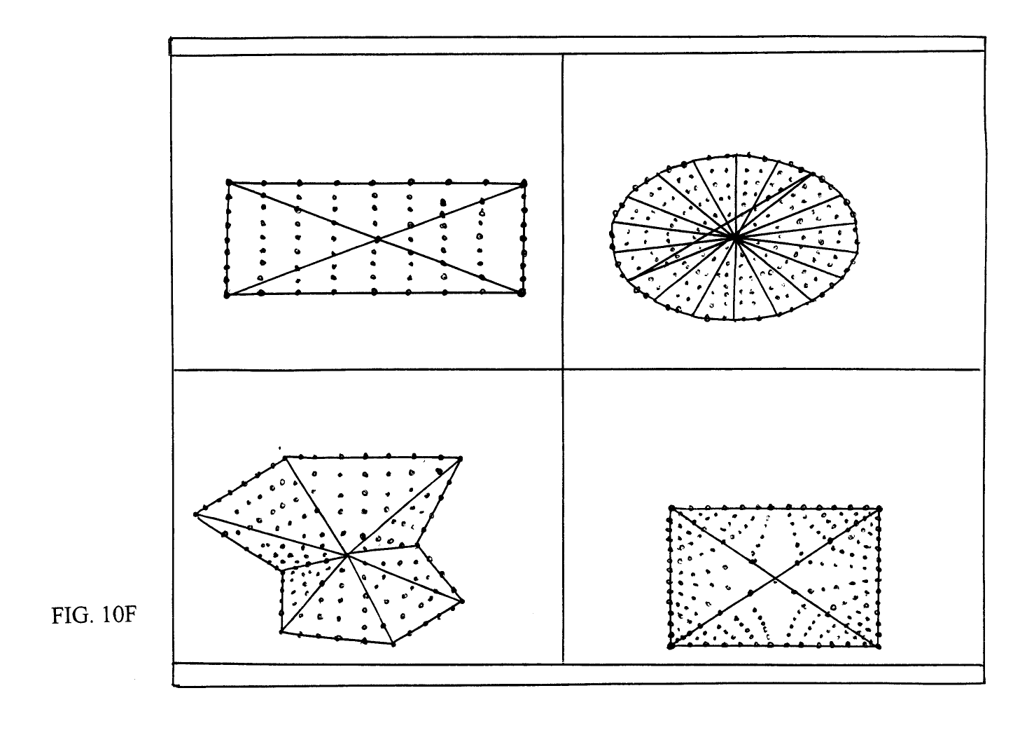

As best shown in FIGS. 10A to 10F, the illustrated reflector 16 has a forward facing reflector surface 60 formed by segments 62 of second order surfaces such as, for example, ellipsoids. Each of the ellipsoids has a first focal point 64 where the energy source 14 is located and a second focal point 66 located somewhere on the surface 68 to be illuminated (sometimes referred to as the target surface). The surface 68 to be illuminated can be a plane or any other desired shape. The number of ellipsoids forming the segments 62 can be as small as a half dozen or so, or can be as large as several hundred or more. Using a larger number of ellipsoids gives more detailed control over the illumination pattern. The illumination pattern is specified or predetermined by indicating how much energy is desired to arrive at each of the selected focal points 66 on the surface 68 to be illuminated. By altering the quantity and location of the focal points 66 and the amount of light energy to reach each of the focal points 66, illumination patterns of any desired shape and light distribution can be obtained.

Because the locations of the two focal points 64, 66 of each ellipsoid are predefined, the only parameter of the ellipsoid that can be varied is its “ellipticity”. In practical terms, this is the size of the ellipsoid. A complete ellipsoid would surround the energy source, and no energy would reach the target surface 68. Hence, an aperture must be defined, and portions of the ellipsoids that are within the aperture are not considered during calculations to size and shape the reflector surface 60. One particularly good choice for an aperture shape is the frustum formed by the point where the energy source 14 is located, and the perimeter of the area to be illuminated. This results in a “congruent” reflector design. A “congruent” reflector assures that both the direct and reflected energy falls on the target surface 68.

The reflector shape is defined as the intersection of all the ellipsoids in the system, or as the volume that is contained inside all of the ellipsoids. The surface 60 of the reflector 16 is formed by segments 62 of the different ellipsoids. The ellipsoids intersect each other in a fairly complicated pattern, but the only portions of each ellipsoid that are relevant to the reflector definition are those portions that are closer to the source point (in any direction from the light source) than any of the other ellipsoid surfaces. The resulting surface is a patchwork of ellipsoid segments 62 that meet each other and are bounded by the curves of intersection of the various ellipsoids. One good way to imagine this surface is to picture a large block of wood, and consider what is left after the wood outside of each ellipsoid shape is carved away. The resulting shape is a solid, bounded by a collection of ellipsoidal patches. Each patch is the result of one particular ellipsoid being closer to the center of the block than any of the other ellipsoids, at least over some region.

The solid angle that each patch subtends from the energy source 14 controls how much energy that segment 62 of the reflector surface 60 will send to its second focal point 66, on the target surface 68. By adjusting the sizes of the ellipsoids, the distribution of energy on the target surface 68 can be controlled.

The ellipsoid sizes are preferably adjusted so that a particular energy distribution is obtained. One term used to describe this process is a “visibility set”. In practical terms, the visibility set of an ellipsoid is the part of an ellipsoid that the energy source 14 can see, because it is closer to the energy source 14 than the other ellipsoids. It is the set of points on an ellipsoid that are not occluded by some other ellipsoid.

The visibility sets can be calculated by an obvious brute force method of tracing rays from the energy source 14 in all directions, and compare the intersection distances for all of the ellipsoids. The ellipsoid that was closest to the energy source 14 would then have one point in its visibility set defined on that traced ray. There are at least two problems with this brute force approach. First, it is not continuous. It can only provide estimates of the areas of the visibility sets, and the accuracy of the estimates depends on the number of rays traced. The area estimate changes in discrete steps as the ellipsoid parameters are adjusted, and this limits both the precision and the stability of the optimization process. Second, tracing large numbers of rays takes a long time. This limits the brute force method to relatively simple systems with small numbers of ellipsoids.

The method according to the present invention, solves the equations that describe the intersection of ellipsoid shapes. Every pair of (confocal) ellipsoids intersects in an ellipse, and those ellipses can be projected onto a unit sphere where they become circles. The circles in turn intersect each other on the sphere, and the points of intersection divide the circles into arcs. All of those circles and their intersection points are calculated, and the resulting arc segments are sorted into closed loops that define the boundaries of the visibility sets. A line integral along each closed loop is then calculated to determine the areas, and the associated solid angles, of the visibility sets. To accomplish this, a number of data structures are used to represent the geometry. Data structures are defined to represent the circles and their points of intersection, and those structures are entered into “linked lists” for processing. The lists of intersection points contain pointers to the circles they were derived from, and a list of circles contains pointers to the ellipsoids they were derived from. Associated data such as vertex angles and arc angles is also stored in the linked lists.

The intersection of a collection of ellipsoids generates a considerable number of arcs and vertices, not all of which are actually on the intended reflector surface. The lists are sorted, and arcs and vertices that are not on the boundaries of the visibility sets are eliminated. The arcs and vertices are then sorted into a consistent order to form closed loops bounding the visibility sets. Once these closed loops are defined, a loop integral can be calculated and the area, and associated solid angle, of each visibility set can be calculated.

This method is continuous, and plays well with the optimization process. It is also much faster than ray tracing. Its major limitation is that the calculation load builds up somewhat faster than the square of the number of ellipsoids used. For large numbers of ellipsoids, the calculation can take several hours. One of it greatest strength is that it is continuous, and the boundary curves are precisely defined. This makes it highly amenable to exporting data to a CAD program.

In an effort to calculate the visibility set in a shorter time it was realized that the problem of solving for visibility sets was equivalent to a generalized Voronoi problem. In the standard Voronoi problem, a plane is partitioned into the regions (set of points) that are closer to some particular point (in a set of reference points) than to any other reference point. In the generalized problem that we chose, the reference points are replaced by the ellipsoids and the space of directions from the light source point are partitioned into regions that are closer to one particular ellipsoid than to any of the others. This problem is solved in our implementation by mapping the space of directions onto the plane in a way that keeps the projected solid angles of the space of directions in constant proportion to the areas of the plane. In addition, the distance from the light source is mapped to a z-height above the plane. This mapping effectively transforms the collection of ellipsoids into curved sheets that span the full area of a “map of the world” that represents the different directions from the source. This transforms the original distance problem into a depth sorting problem.

While the above described embodiment utilizes segments of ellipsoids, it is noted that any suitable second order surface or focal conic surface can be utilized such as ellipsoids, paraboloids, hyperboloids, and the like. When using ellipsoids, the reflected energy is partitioned into discrete packets, and each packet of energy is associated with a particular ellipsoid local point on the surface to be illuminated. When using paraboloids the energy is partitioned into a discrete set of directions, each direction corresponding to the axis of one of the paraboloids. Those directions can be considered as focal points that are infinitely distant. In both cases, the reflector is defined as the surface of the volume that is contained within the entire set of either ellipsoids or paraboloids.

The methods involving paraboloids and ellipsoids can be adapted to cover the case of a reflector defined in terms of hyperboloids. In this case, the focal points would be virtual, and the energy would be partitioned into packets that appeared to be emanating from virtual focal points. In other words, the focal points in the hyperboloid case would be images of the light source formed by reflection from the hyperboloids. The illumination target in this case would be a reflected image in virtual space (i.e. behind the mirror) rather than a position or direction in real space.

There is a class of surfaces called “Cartesian ovals” which can be used to create lenses that have focal properties analogous to the focal properties of the ellipsoid, paraboloid and hyperboloid. In general, these surfaces can be used to gather the light from a source at one focal point, and focus it by refraction to a second focal point. In practice, this sort of lens is often formed with one surface of spherical shape, and the other surface of Cartesian oval shape. The spherical surface is then typically formed to the same radius as either the input or output wave front, and does not contribute to the refraction process that maps the source focal point onto the image focal point.

These Cartesian oval surfaces could in principle be used to define a refractive optical system in a manner similar to that already described for the reflective case with ellipsoids, paraboloids and hyperboloids. There would of course be the additional overhead of dealing with the second surface of each lens. The most likely scenario would be to have all of the Cartesian oval lenses share a common spherical surface, on the side of the lens toward the light source. This would effectively reduce the design problem to one of finding a single segmented refractive surface that partitioned the source energy into a set of discrete packets, each associated with one of a set of focal points. The focal points could be real or virtual, as in the reflective case.

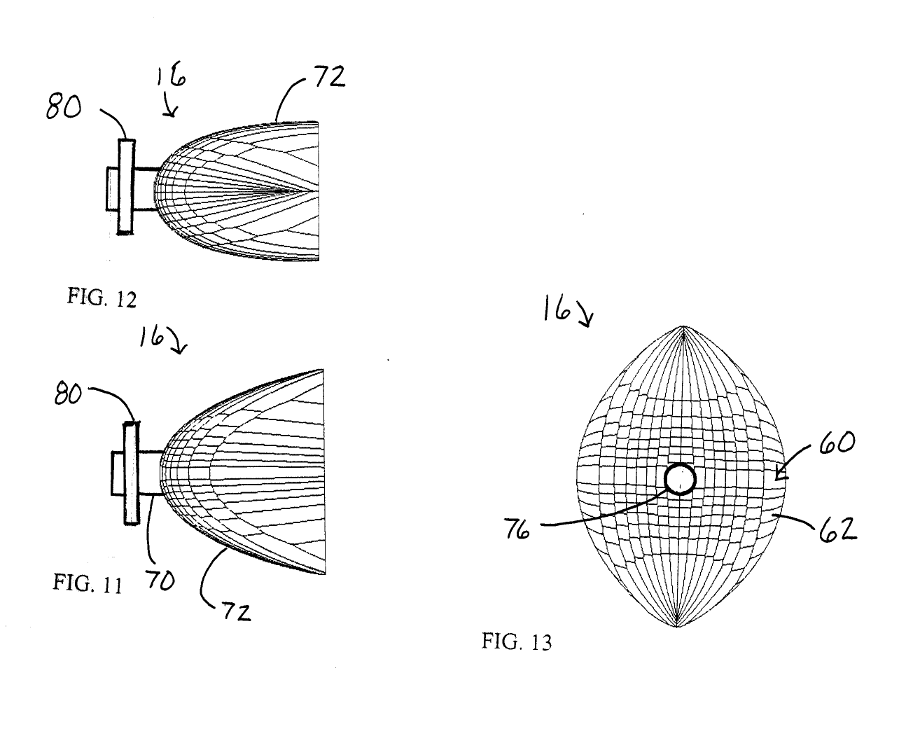

As best shown in FIGS. 11 to 13, the illustrated reflector 16 is segmented as described above, but is trimmed, and is also flexible. The illustrated reflector 16 has a tubular-shaped rearward or connecting portion 70 and a generally cup-shaped forward or reflecting portion 72 forming the oval-shaped (that is elliptical or elliptical like) forward-facing reflector surface 60. The illustrated connecting portion 70 has a central, longitudinally-extending passage 74 that opens into a central opening 76 in the reflector surface 60 for the energy source 14 as described in more detail hereinafter. The central passage 74 is sized and shaped to closely receive the central portion 52 of the lamp assembly 14 for axial sliding of the lamp assembly 14 therein as described in more detail hereinafter. The rear end of the connecting portion 70 forms a rearward-facing, annular-shaped rear abutment or surface 78. The illustrated connecting portion 70 also has a radially-extending circular-shaped flange 80 for securing and positioning the reflector 16 as described in more detail hereinafter. The flange 80 forms a forward-facing, annular-shaped first abutment and a rearward-facing, annular-shaped second abutment positioning the reflector 16 as described in more detail hereinafter. The illustrated reflecting portion 72 is flexible and oval-shaped in its free or unrestrained state and can be deformed to be substantially circular by the deformer 18 as described in more detail hereinafter. In the oval shape, the reflector 16 can produce a rectangular energy pattern at the target surface 68. In the circular shape, the reflector 16 can produce a round energy pattern at the target surface 68. It is noted that the reflector 16 could alternatively be formed to be circular in its free state and deformed to be substantially oval. It is also noted that the reflector 16 can alternatively have any other suitable shapes in its free and deflected shapes so long as they maintain aperture perimeter and reflector surface area constraints. It is further noted that the reflector 16 can alternatively be deformed to more than one additional shape. The reflector 16 is preferably molded of moldable material such as a plastic but can alternatively be formed in any other suitable manner and can alternatively comprise any other suitable material.

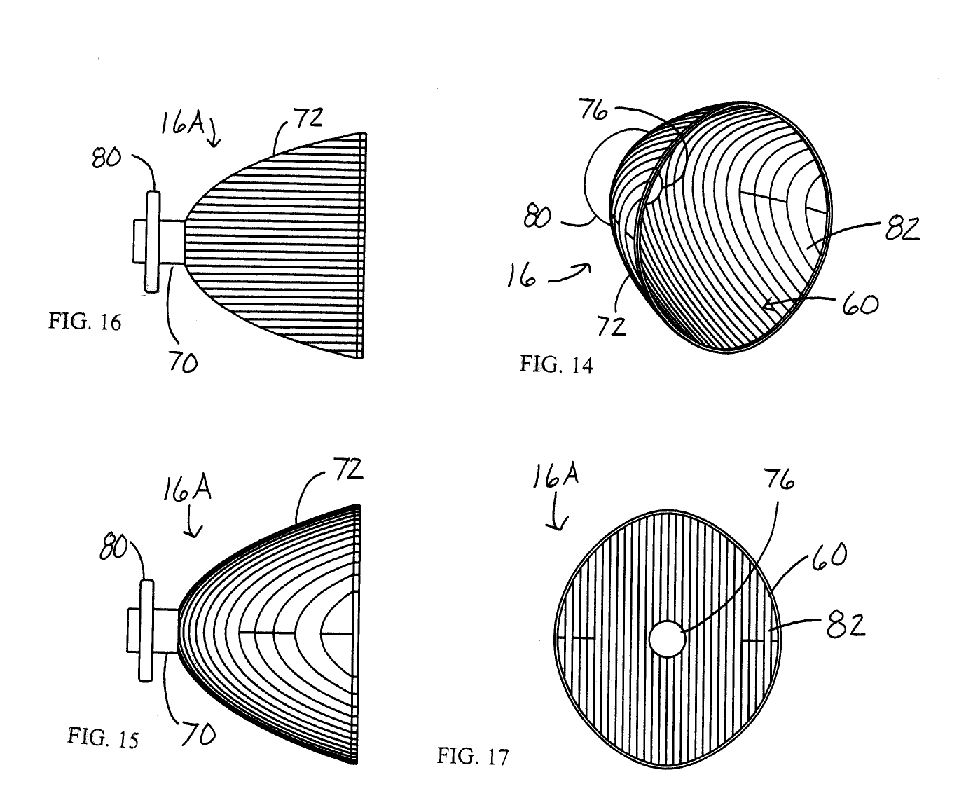

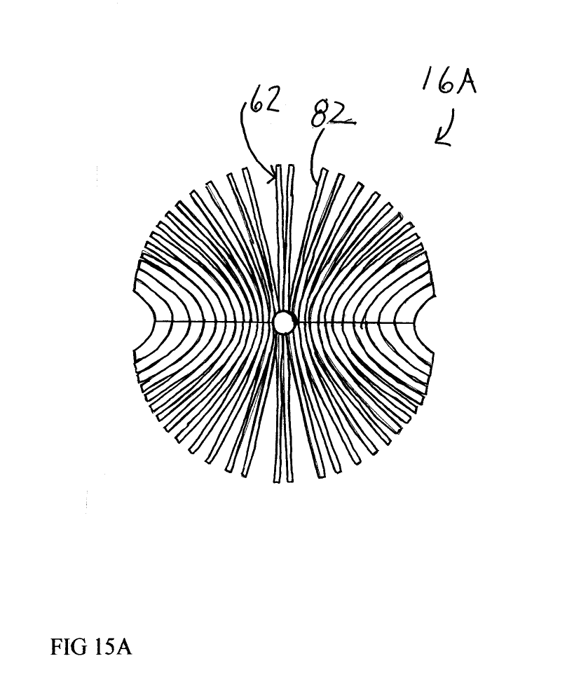

FIGS. 14 to 17, illustrate an alternative reflector 16B where the segments 62 are parameterized as strips 82. The segments 62 can alternatively be parameterized as facets, or the like, by parameterizing segments 62 in two directions. Such parameterization may slightly reduce the optical efficiency but can greatly reduce the manufacturing costs of the reflector 16 by approximating the true second order surfaces described above. Once a segmented reflector surface 60 having second order surfaces is mathematically defined, the total number of surfaces is increased (so that each segment 62 is smaller) so that the reflector surface 60 becomes a more continuous surface. This nearly continuous surface is then sliced into the strips 82 (which each have a curve) like a loaf of bread. The reflector surface 60 can be sliced in both directions to get facets (which each have a curve). These strips and facets 82 approximate the segments 62 of second order surfaces but are less expensive to produce than the true second order surfaces. To further reduce cost, the strips or facets 82 can be flat, that is, planar. The reflector surface 60 is preferably developable, that is, it can be unfolded into a flat plane, which further reduces manufacturing costs. FIG. 15A illustrates a developed flat pattern for forming the reflector of FIGS. 14 to 17.

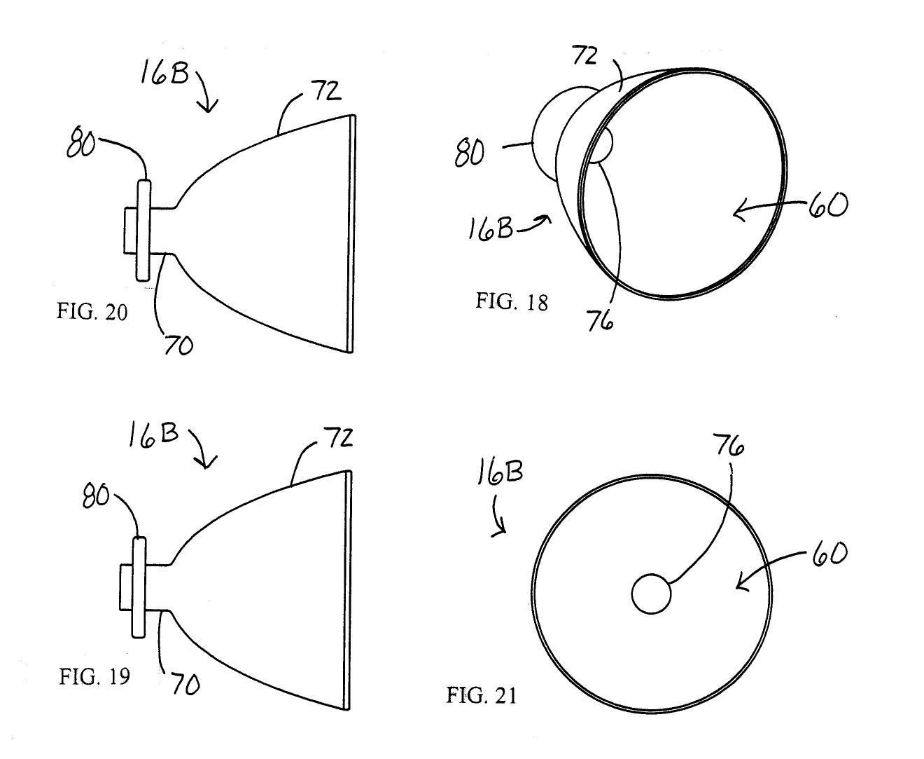

FIGS. 18 to 21 illustrate an alternative reflector 16B that is circular in its free or unrestrained state and has a smooth or unsegmented reflector surface 60. This reflector 16B illustrates that the reflector can be formed in shapes other than oval in its free or unrestrained state and that the reflector surface 60 can be other than formed by segments 62 of second order surfaces or parameterized segments 82 within the scope of the present invention. It is noted that the smooth reflector surface 60 will not obtain a predetermined illumination pattern like the above described segmented reflector surfaces 60.

The forward end of the illustrated front reflector housing 24 is provided with a window 84 which closes the open forward end to protect the reflector 16 and the energy source 14. The illustrated window 84 is generally disk shaped having flat or planar front and rear surface generally perpendicular to the central or optical axis 86 of the system 10. The window 84 can be formed of any suitable material such as, for example, tempered glass or plastic. The illustrated window 84 is secured to the front reflector housing 24 with a window retainer 88. The window retainer 88 can be of any suitable size and shape to hold the window 84 to the front reflector housing 24 and can be secured to the front reflector housing 24 in any suitable manner. It is also noted that if desired, the window 84 can be a lens or other desired optical element, that is, specifically designed to alter or change the energy transmitted therethrough depending on the requirements of the particular optical system 10.

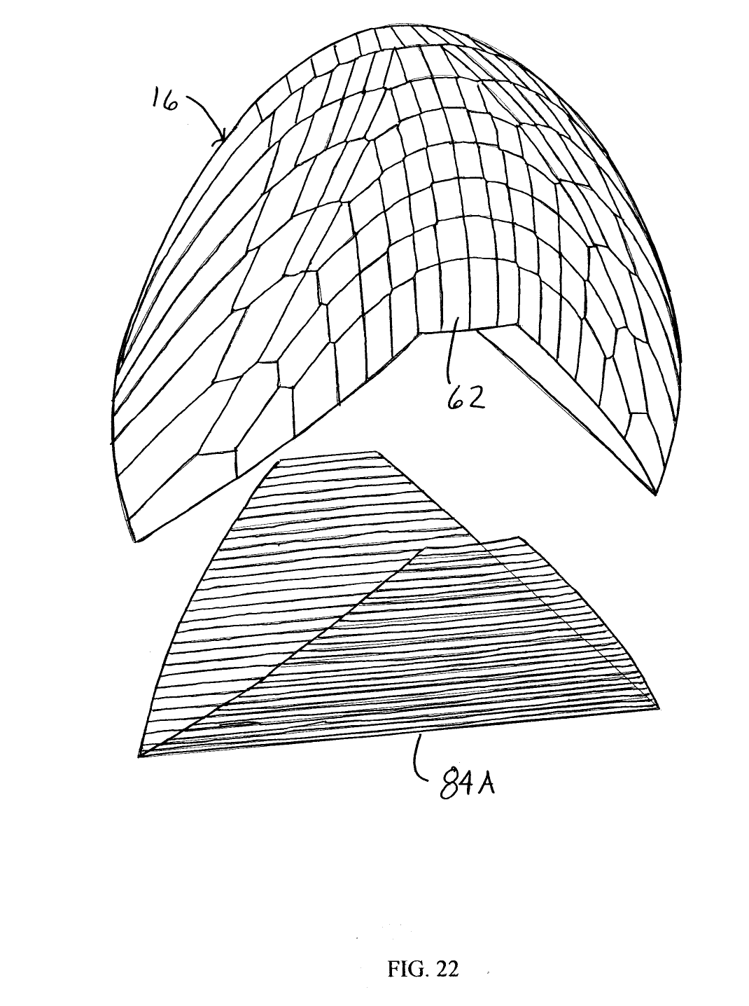

FIG. 22 illustrates an alternative window 84A that is sized and shaped so that it receives and transmits substantially normal energy or light, that is, substantially perpendicular to the portion of the window 84A through which it is passing. The window 84A is preferably sized and shaped so that energy directly reflected by the reflector 16 is received by the window 84A substantially normal to the inner surface of the window 84A to minimize the amount of energy reflected by the window 84A back into the system rather than directly passing through the window 84A. Thus, the window 84A is not flat or planar because the reflector 16 does not form a collimated beam and the window 84A has a shape that is customized for the particular shape of the reflector 16 from which it is receiving energy. The illustrated window 84A is also sized and shaped to fully close the aperture of the reflector 16. Designed in this manner, the amount of energy reflected back toward the reflector 16 by the window 16A is minimized to obtain improved efficiency while having limited impact on the light distribution. It is noted that such a window can be particularly useful for optical systems in applications requiring limited scattering such as, for example, it enables overhead street lights to meet the requirements of IES roadway classification “cutoff”.

The illustrated beam-shape switching mechanism 20 includes a carrier or positioning cam 90 for carrying the energy source 14 and the reflector 16 relative to the reflector housings 24, 26 and a thumb switch or manual driver 92 for selectively moving the positioning cam 90. The components of the switching mechanism 20 can comprise any suitable material such as, for example, metal, plastic, or the like. It is noted that the components of the switching mechanism 20 can alternatively have any other suitable form within the scope of the present invention.

The illustrated positioning cam 90 is substantially cylindrically shaped having an outer perimeter sized and shaped to cooperate with the driver 92 as described in more detail hereinafter. The illustrated positioning cam 90 has a central, longitudinally-extending passage 94 extending therethrough. The illustrated passage 94 has a first or forward enlarged portion 96 sized and shaped to receive the flange 80 of the reflector 16 to secure the reflector 16 to the positioning cam 90 so that the reflector 16 is carried with the positioning cam 90. The illustrated forward enlarged portion 96 forms forward and rearward facing abutments sized for permitting and limiting relative movement of the reflector 16 relative to the positioning cam 90. The illustrated passage 94 also has a second or rearward enlarged portion 98 sized and shaped to receive the flange 54 of the energy source 14 therein with the energy source 14 extending out of the forward end of the positioning cam 90 and into the reflector 16 through the opening 76 along the central axis 86, to secure the energy source 14 to positioning cam 90 so that the energy source 14 is carried with the positioning cam 90. The illustrated rearward enlarged portion 98 forms forward and rearward facing abutments sized for permitting and limiting relative movement of the energy source 14 relative to the positioning cam 90. In the illustrated embodiment, one of the contact springs 56 engages the forward facing abutment of the rearward enlarged portion 98 so that the forward facing abutment of the energy source flange 54 is biased into engagement with the rearward facing abutment of the rearward enlarged portion 98 of the passage 94. The illustrated positioning cam 90 also has a pin 100 sized and shaped to cooperate with the driver 92 as described in more detail hereinafter. The illustrated pin 100 extends perpendicularly from a side of the positioning cam 90 in an outward direction and is generally cylindrical shaped having a circular cross-section. It is noted that the pin 100 can alternatively have any other suitable form.

The illustrated driver 92 is generally cylindrically shaped having an outer perimeter sized and shaped to be closely received within the passage 32 of the rear reflector housing 26 for rotation therein. The illustrated driver 92 includes a knob or engagement portion 102 that extends through the elongate opening 40 in the rear reflector housing 26. The knob portion 102 is sized and shaped to have opposed engagement surfaces which can be pushed by the thumb of a user holding the main body 28 in their hand so that the driver 92 can be selectively pivoted about the central axis 86 in either direction. The knob portion 102 can be of any desired size and shape. The illustrated driver also has a main or body portion 104 that is generally tubular-shaped having a central, longitudinally-extending passage 106 extending entirely therethrough. The passage 106 is sized and shaped to closely receive the positioning cam 90 for sliding longitudinal movement therein. The illustrated body portion 104 also has a helical shaped slot 108 sized and shaped to receive the pin 100 of the positioning cam 90 to convert rotational motion of the driver 92 relative to the rear reflector housing 26 into linear movement of the positioning cam 90 relative to the rear reflector housing 26 along the central axis 86. It is noted that the pin and slot connection 100, 108 can take any other suitable form or can be any alternative means for converting the rotational motion into the linear motion.

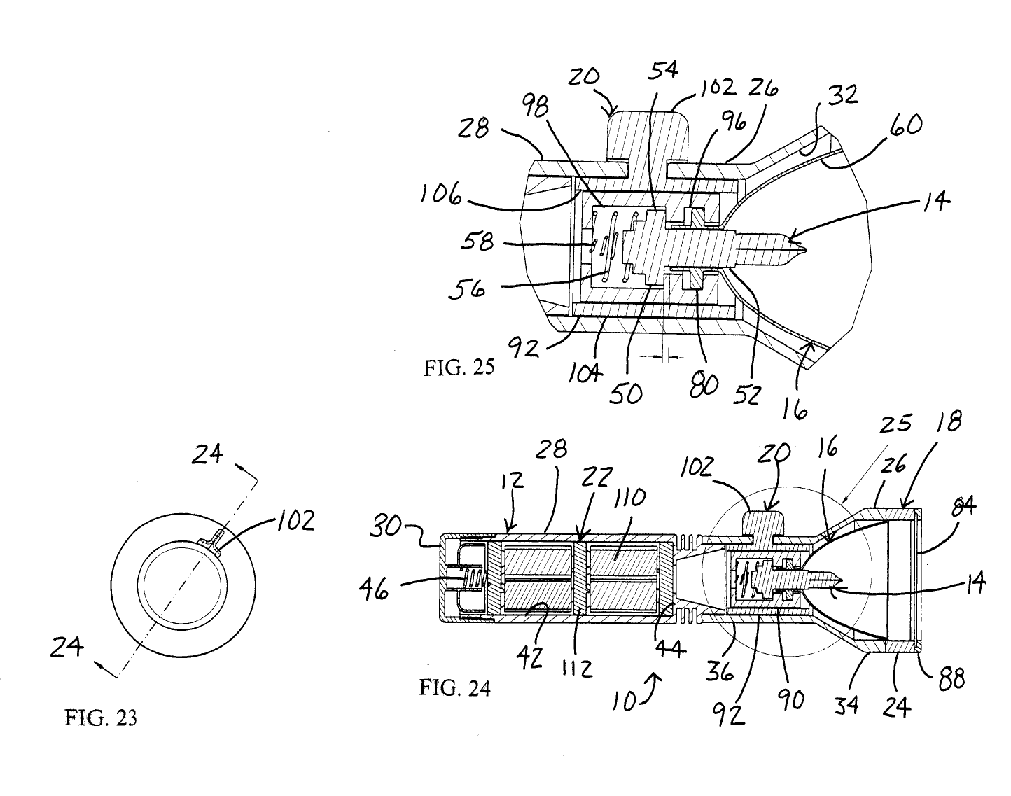

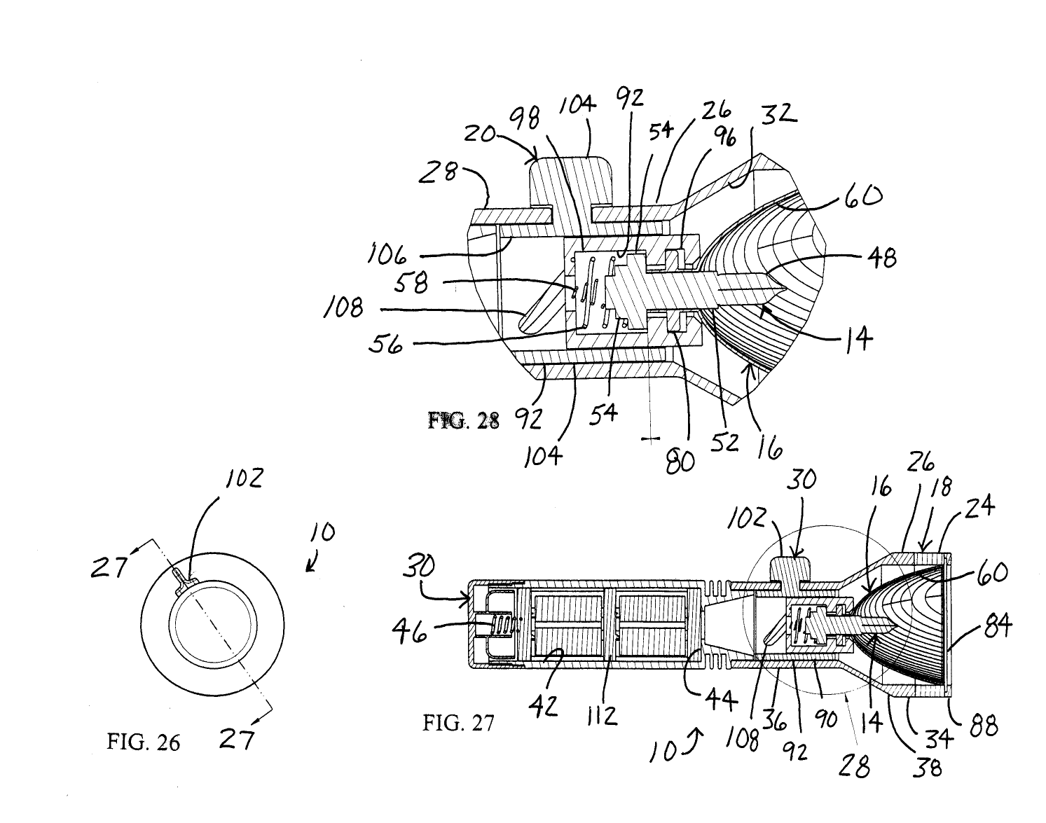

The illustrated switching mechanism 20 has three positions: a central or off position (FIGS. 2 to 4); a right or circular position (FIGS. 23 to 25); and a left or oval position (FIGS. 26 to 28). It is noted that the switching mechanism 20 can alternatively have a greater or fewer number of positions within the scope of the present invention. In the off position, the knob portion 102 of the driver 92 is centrally located within the opening 40 so that the pin 100 of the positioning can 90 is centrally located within the slot 108 of the driver 92 and the forward end of the reflector 16 is located between the ends of the deformer 18. Preferably, the energy source 14 is unenergized when the switching mechanism is in the off position as described in more detail hereinafter.

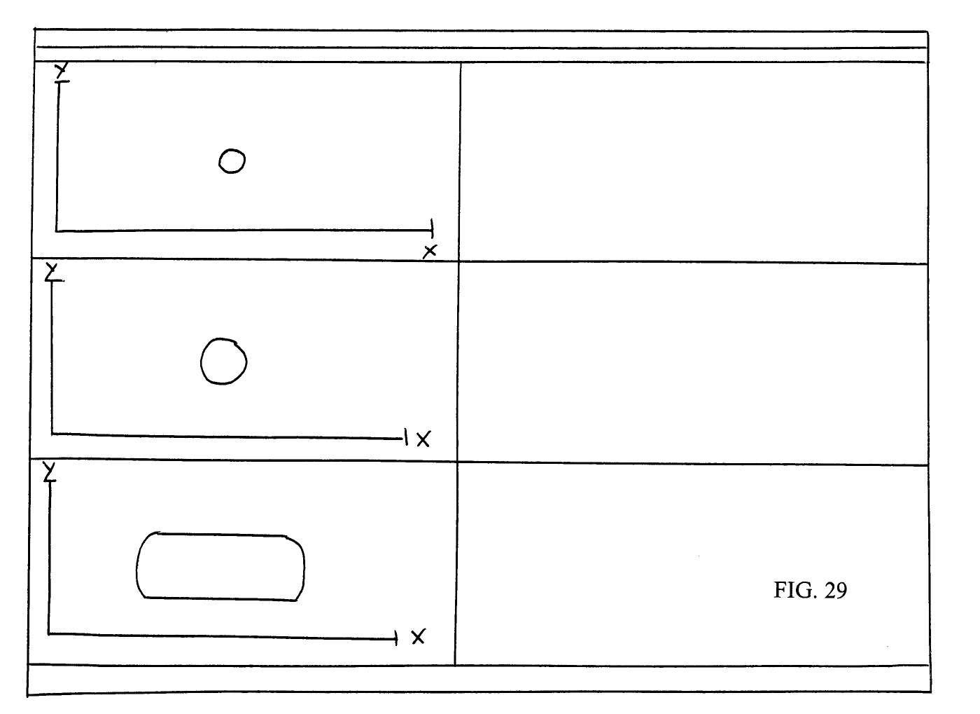

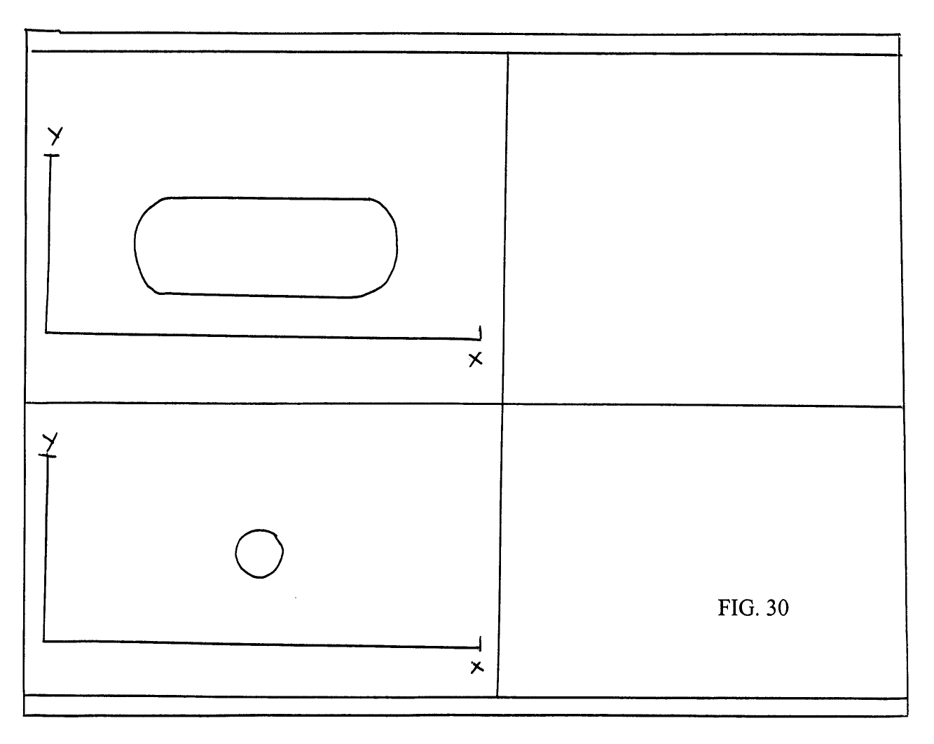

FIGS. 23 to 25 illustrate the flashlight 10 with the switching mechanism 20 and the reflector 16 in the first reflector shape or circular position. That is, when the knob portion 102 is moved to the right. As the user pushes the knob portion 102 to the right, the body portion 104 of the driver 92 rotates within the rear reflector housing 26 in a clock-wise direction as viewed in FIG. 23. The rotation of the body portion 104 rotates the helical slot 108 to move the pin 100 rearwardly along the slot and the positioning cam 90 in a rearward direction along the central axis 86. The positioning cam 90 carries the energy source 14 rearwardly therewith. The positioning cam 90 also carries the reflector 16 rearwardly therewith so that the reflector 16 moves to the rear end of the deformer 18 and is deformed to a round or circular shape. It is noted however, that the reflector 16 does not move until the forward side of the reflector flange 80 engages the rearward facing abutment of the positioning cam 90 so that the reflector 16 is pushed rearward by the rearward motion of the positioning cam 90. Thus, the reflector 16 may move, depending on whether the knob portion 102 was last moved left or right, a shorter distance than the energy source 14 so that the there is relative motion between the reflector 16 and the energy source 14 to substantially position the optical center of the energy source 14 at the first focal point 64 of the round-shaped reflector 16. Preferably, the energy source 14 is automatically energized when the switching mechanism 20 is moved the right position so that a substantially round or circular-shaped energy pattern is formed at the target surface 68 (best shown in FIGS. 29 and 30).

FIGS. 26 to 28 illustrate the flashlight 10 with the switch mechanism 20 and the reflector 16 in the second reflector shape or oval position. That is, when the knob portion 102 is moved to the left. As the user pushes the knob portion 102 to the left, the body portion 104 of the driver 92 rotates within the rear reflector housing 26 in a counter clock-wise direction as viewed in FIG. 26. The rotation of the body portion 104 rotates the helical slot 108 to move the pin 100 forwardly along the slot 108 and the positioning cam 90 in a forward direction along the central axis 86. The positioning cam 90 carries the energy source 14 forwardly therewith. The positioning cam 90 also carries the reflector 16 forwardly therewith so that the reflector 16 moves to the forward end of the deformer 18 and is deformed to or assumes its oval shape. It is noted however, that the reflector 16 does not move until the forward side of the energy source flange 54 engages the rear end 78 of the reflector 16 so that the reflector 16 is pushed forward by the forward motion of the energy source 14 and the positioning cam 90. Thus, the reflector 16 may move, depending on whether the knob portion 102 was last moved left or right, a shorter distance than the energy source 14 so that the there is relative motion between the reflector 16 and the energy source 14 to substantially position the optical center of the energy source 14 at the first focal point 64 of the oval-shaped reflector. Preferably, the energy source 14 is automatically energized when the switching mechanism 20 is in the left position so that a substantially rectangular-shaped energy pattern is formed at the target surface 68 (best shown in FIGS. 29 and 30).

In the illustrated embodiment the relative movement between the reflector 16 and the energy source 14 is about 0.060 inches to adjust for the differing position of the first focal point 64 of the reflector shapes. It is noted that any other suitable movement or adjustment can be utilized. It is also noted that the adjustment can be obtained in any other suitable manner such as, for example, movement of the energy source 14 relative to the positioning cam 90 rather than the reflector 16. It is further noted that the adjustment can alternatively be eliminated depending on the desired performance of optical system 10.

The illustrated power source and switch assembly 22 includes a plurality of batteries 110 held within a battery carrier 112 sized and shaped to fit within the main body 28. The batteries 110 can be of any suitable type and are operatively connected to the energy source 14 to selectively provide power thereto. It is noted that the battery carrier 112 can be of any suitable design. The power source and switch assembly 22 also includes an electrical switch of any suitable type to selectively connect and disconnect the batteries 110 with the energy source 14. Preferably, the electrical switch can be combined with the beam-shape switching mechanism 20 to automatically provide power when the knob portion 102 is out of the off position to disconnect power when the knob portion 102 is in the off position. Alternatively, the electrical switch can be a separately actuated switch such as, for example, a push or rotary switch located at the end cap 30.

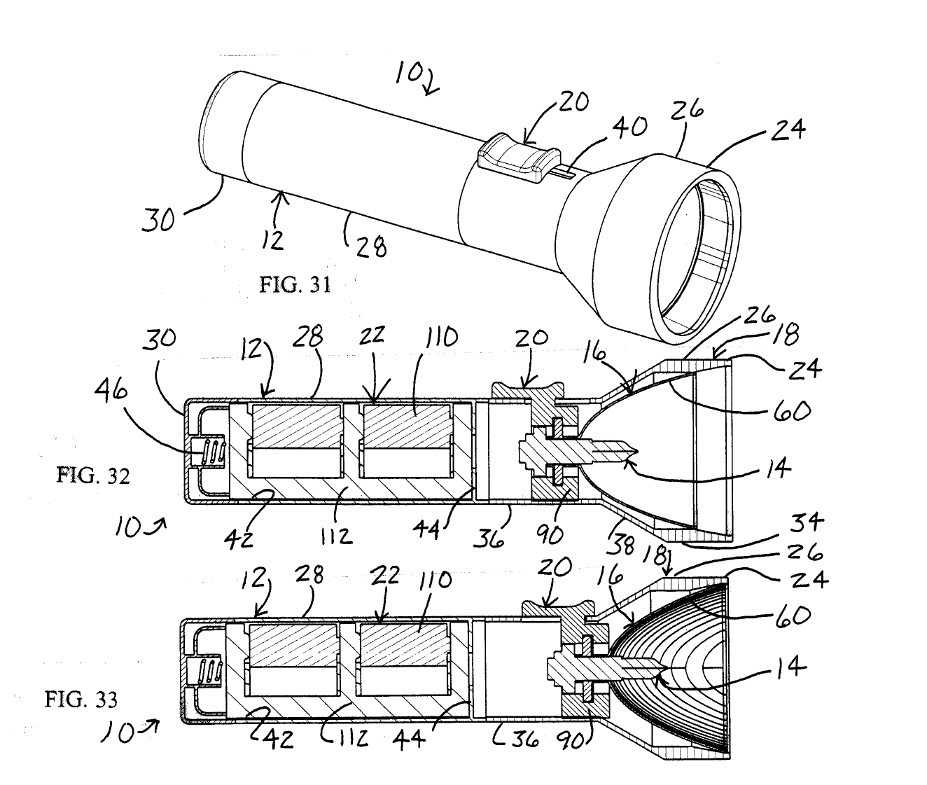

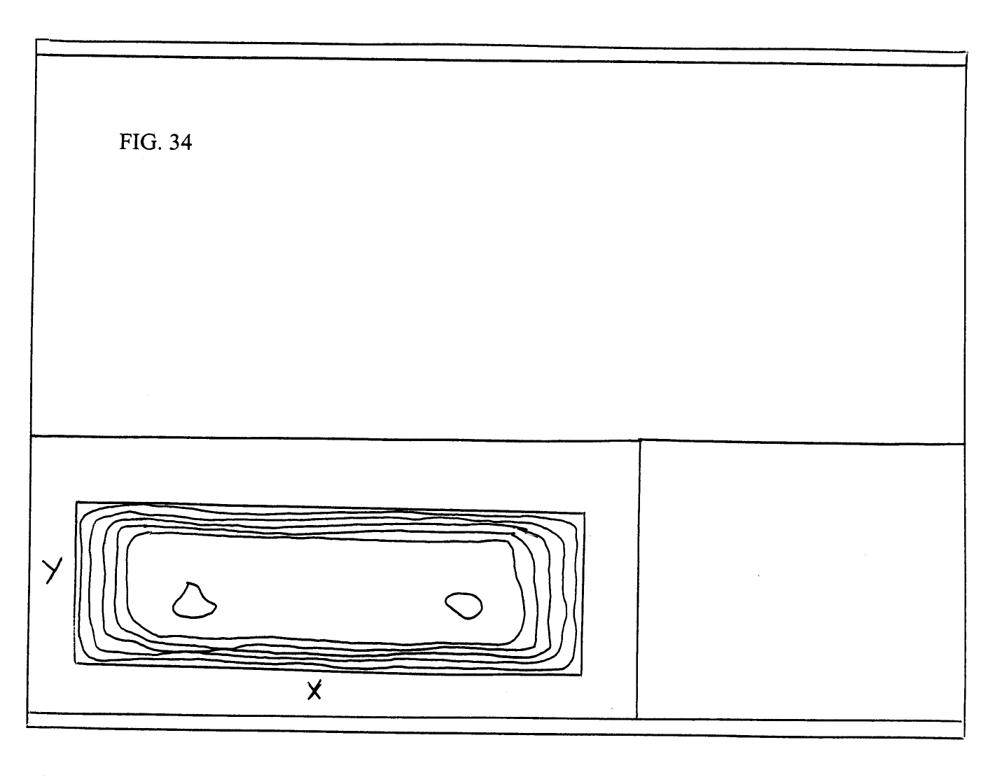

FIGS. 31 to 33 illustrate an optical system 10 in the form of a portable, handheld flashlight according to a second illustrated embodiment of the present invention. The flashlight 10 according to the second embodiment is substantially the same as the flashlight according to the first embodiment except that the knob portion 102 of the beam-shape switching mechanism 20 moves linearly rather than rotates to linearly move the energy source 14 and the reflector 16. This embodiment illustrates that the beam-shape switching mechanism 20 can have any suitable form within the scope of the present invention.

It should be appreciated from the foregoing detailed description of the present invention that the present invention provides improved performance over prior art systems because illumination patterns with efficiencies and uniformities heretofore unobtainable can be obtained by the present invention. For example, see FIG. 34 where a reflector 16 according to the present invention is shown to obtain a total luminaire efficiency of at least 90%, and more particularly 90.7%, and a target efficiency of at least 80% and more particularly 85%, while achieving an IES roadway classification of “cutoff”.

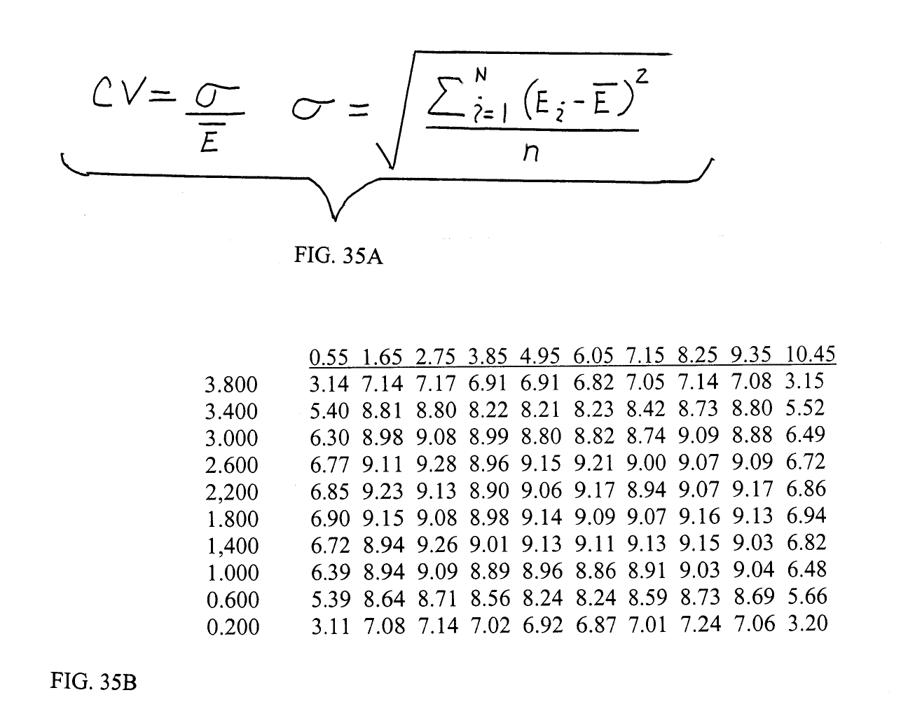

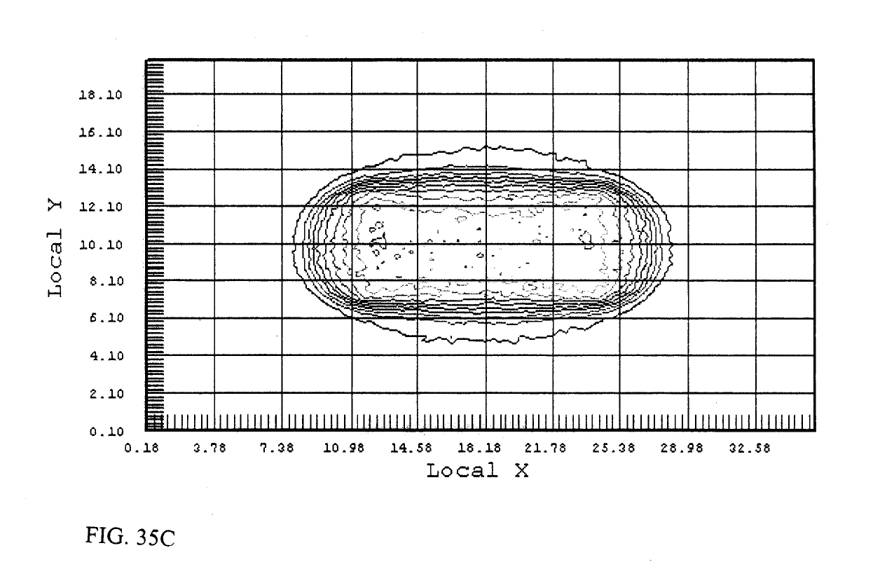

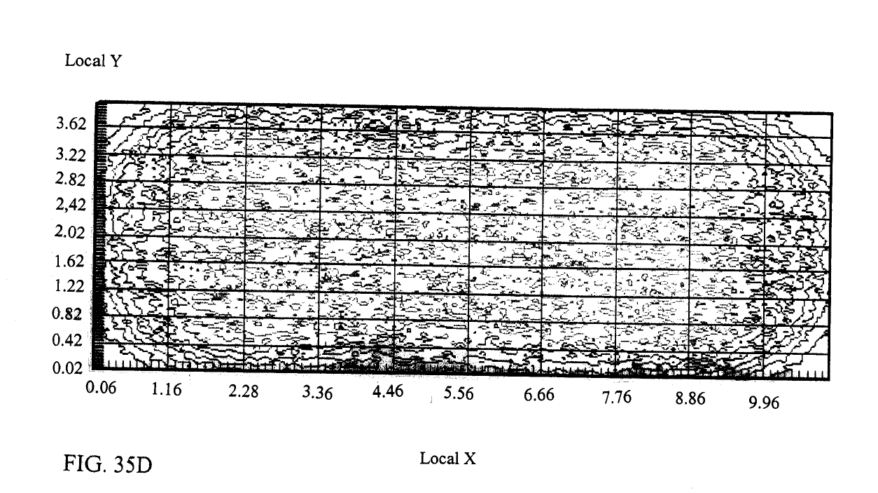

A reflector according to the present invention can also produce a rectangular shaped beam with near uniform distribution of luminance on the target surface. Uniformity can be expressed by the Coefficient of Variation (CV) which is determined by the equation shown in FIG. 35A. The CV is the standard deviation of illumination measured at grid points on the illumination plane (see FIG. 35B for a table showing an example) divided by the mean of the illumination measured at the grid points. The illumination at the grid points is measured in foot candles and FIGS. 35C and 35D show examples of the uniformity obtained by the reflector according to the present invention. Within this specification and claims the term “near uniform” means having a CV in the range of about 1.5 to about 2.0.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. An optical system comprising, in combination:
an energy source;
a reflector formed by segments of second order surfaces and partially surrounding the energy source to reflect energy produced by the energy source; and
wherein the segments of the second order surfaces are each sized and shaped to provide a predetermined amount of energy in a predetermined energy pattern on a target surface.

2. The optical system according to claim 1, wherein the second order surfaces comprise at least one of ellipsoids, paraboloids, and hyperboloids.

3. The optical system according to claim 1, wherein the optical system can obtain an optical reflector efficiency of at least 90% when material forming reflector has a reflectivity of at least 95%.

4. The optical system according to claim 1, wherein the reflector comprises a moldable material.

5. The optical system according to claim 1, wherein the predetermined energy pattern is rectangular with near uniform distribution.

6. The optical system according to claim 1, wherein the energy source is an electric light bulb for producing visible light.

7. The optical system according to claim 6, wherein the optical system is part of a portable illumination device.

8. The optical system according to claim 7, wherein the portable illumination device is a handheld flashlight.

9. The optical system according to claim 8, wherein the predetermined energy pattern is rectangular with uniform distribution.

10. The optical system according to claim 1, wherein the reflector is flexible and deformable from a first shape to a second shape.

11. The optical system according to claim 1, wherein the reflector is developable whereby it can be unfolded into a flat plane.

12. An optical system comprising, in combination:
an energy source;
a reflector partially surrounding the energy source to reflect energy produced by the energy source and formed by parameterized segments approximating second order surfaces sized and shaped to provide a predetermined amount of energy in a predetermined energy pattern on a target surface; and
wherein the segments are parameterized as one of facets and strips.

13. The optical system according to claim 12, wherein the second order surfaces comprise at least one of ellipsoids, paraboloids, and hyperboloids.

14. The optical system according to claim 12, wherein the optical system obtains an optical reflector efficiency of at least 90% when material forming reflector has a reflectivity of at least 95%

15. The optical system according to claim 12, wherein the reflector comprises a moldable material.

16. The optical system according to claim 12, wherein the predetermined energy pattern is rectangular with near uniform distribution.

17. The optical system according to claim 12, wherein the energy source is an electric light bulb for producing visible light.

18. The optical system according to claim 17, wherein the optical system is part of a portable illumination device.

19. The optical system according to claim 18, wherein the portable illumination device is a handheld flashlight.

20. The optical system according to claim 19, wherein the predetermined energy pattern is rectangular with uniform distribution.

21. The optical system according to claim 12, wherein the reflector is flexible and deformable from a first shape to a second shape.

22. The optical system according to claim 12, wherein each of the facets and strips is flat.

23. The optical system according to claim 12, wherein the reflector is developable whereby it can be unfolded into a flat plane.

24. An optical system comprising, in combination:
an energy source;
a flexible reflector having a first shape and partially surrounding the energy source to reflect energy produced by the energy source;
wherein the first shape provides a first predetermined energy pattern; and
a deformer for selectively deforming the flexible reflector to a second shape; and
wherein the second shape provides a second predetermined energy pattern different from the first predetermined energy pattern.

25. The optical system according to claim 24, wherein the reflector is formed by segments of second order surfaces.

26. The optical system according to claim 25, wherein the second order surfaces comprise at least one of ellipsoids, paraboloids, and hyperboloids.

27. The optical system according to claim 24, wherein the reflector is formed by parameterized segments approximating second order surfaces sized and shaped to provide a predetermined amount of energy in a predetermined energy pattern on a target surface and wherein the segments parameterized as one of facets and strips of appropriate

28. The optical system according to claim 24, wherein the optical system obtains an optical reflector efficiency of at least 90% when material forming reflector has a reflectivity of at least 95%.

29. The optical system according to claim 24, wherein at least one of the reflector and the deformer is movable to change the reflector between the first shape and the second shape.

30. The optical system according to claim 24, wherein the reflector is in the first shape when in a free-state and resiliently returns to the first shape when unrestrained.

31. The optical system according to claim 24, wherein one of the first and second shapes is round and one of the first and second shapes is oval.

32. The optical system according to claim 24, wherein one of the first and second predetermined energy patterns is circular and one of the first and second predetermined energy patterns is rectangular.

33. The optical system according to claim 24, wherein the reflector comprises a moldable material.

34. The optical system according to claim 24, wherein one of the first and second predetermined energy patterns is rectangular with near uniform distribution.

35. The optical system according to claim 24, wherein the energy source is an electric light bulb for producing visible light.

36. The optical system according to claim 35, wherein the optical system is part of a portable illumination device.

37. The optical system according to claim 36, wherein the portable illumination device is a handheld flashlight.

38. An optical system comprising, in combination:
an energy source;
a reflector partially surrounding the energy source to reflect energy produced by the energy source; and
a window sized and shaped so that energy reflected by the reflector is received by the window substantially normal to an inner surface of the window.
